(19) United States
(12) Patent Application Publication
(10) Pub. No.: US 2015/0377556 A1
(43) Pub. Date: Dec. 31, 2015

(54) INFRARED FURNACE, INFRARED HEATING METHOD AND STEEL PLATE MANUFACTURED BY USING THE SAME

(71) Applicant: AISIN TAKAOKA CO., LTD., Toyota-shi, Aichi (JP)

(72) Inventor: Katsunori ISHIGURO, Aichi (JP)

(73) Assignee: AISIN TAKAOKA CO., LTD., Toyota-shi, Aichi, OT (JP)

(21) Appl. No.: 14/765,545

(22) PCT Filed: Jan. 30, 2014
(86) PCT No.: PCT/IB2014/058655

§ 371 Date: Aug. 3, 2015

(30) Foreign Application Priority Data
Feb. 1, 2013 (JP) 2013-018878

(51) Int. Cl. F27D 11/12; C21D 1/34; C21D 8/02; C21D 9/46; C21D 1/18

(52) U.S. Cl. CPC F27D 11/12; C21D 9/46; C21D 1/18; C21D 8/0205; C21D 8/0294; C21D 1/34

(57) ABSTRACT

An infrared furnace is able to heat a first region and a second region of a work in different temperature regions, provided with a plurality of infrared lamps opposing the work, and a member positioned between the work and the plurality of infrared lamps apart from the work and the infrared lamps, to be arranged above a boundary region between the first and second regions.

### CROSS-REFERENCE TO RELATED APPLICATIONS

The present application claims priority based on JP Patent Application 2013-018878 filed in Japan on Feb. 1, 2013, whose entire disclosure is incorporated herein by reference thereto.

### TECHNICAL FIELD

The present invention relates to an infrared furnace, an infrared heating method and a steel plate manufactured by using the same, and especially relates to the infrared furnace and the infrared heating method which can heat one work in different temperature regions and the steel plate with which different strength regions are formed in one sheet.

### BACKGROUND

In connection with needs growing to the weight saving aiming at the improvement in fuel consumption or collision safety of the body, the die quenching method has attracted attention as a production method of automobile parts. The die quenching method is a construction method which quenches a steel plate by carrying out rapid-cooling of the heated steel plate simultaneously with forming (molding) by means of press metallic dies.

In addition, as a method of heating a steel plate for quenching the steel plate, an infrared heating method has attracted attention. The infrared heating method is a method to make a work generate heat, by irradiating the work with infrared rays and making the work absorb infrared rays.

Moreover, as to parts for vehicles such as automobile parts, there is a demand to have strength variations within one part for saving steps of welding high strength parts and low strength parts to manufacture one part. As for such parts, there is an advantage that strength is secured by a high strength region while a low strength region is easy to process.

The patent literatures relating to the above Background are mentioned below.

Proposed in Patent Literature 1 is arranging a sheet material having a predetermined form between a steel plate and an infrared lamp(s), and setting at least a part of heating intensity distribution of a side not covered by a sheet material of a steel plate so as to differ from a heating intensity distribution of a side covered by the above-mentioned sheet material of the steel plate.

Proposed in Patent Literature 2 is an infrared heating device which irradiates the first region of a steel plate with more weak infrared rays and the second region of this steel plate with strong infrared rays.

Proposed in Patent Literature 3 is an infrared heating device which sets output intensity of all the infrared lamps to be turn on at a same rate while choosing the number of the infrared lamp to be turn on according to a target heating temperature of a steel plate.

Proposed in Patent Literature 4 is an infrared heating device which makes an output of lamp(s) of a predetermined sequence(s) low and an output of lamp(s) of other sequence(s) high, among a plurality of infrared lamps arranged in a matrix shape, in order to control the heating state of a steel plate for every region.

Proposed in Patent Literature 5 is a pressing method that starts press-forming of a steel plate in a state where the temperature of the remainder part of a steel plate is less than room temperature to Ar-1 transformation point while infrared heating a part of the steel plate not less than Ar-1 transformation point.

### CITATION LIST

### Patent Literature (PTL)

### [PTL 1]

JP4575976B

### [PTL 2]

JP2011-200866A

### [PTL 3]

JP2011-7469A

### [PTL 4]

JP2011-99567A

### [PTL 5]

JP2005-193287A

### SUMMARY

The following analysis is given by the present invention. The disclosures of the above listed literatures are each incorporated herein by reference thereto in their entirety.

For example, as for one sheeted steel plate, a low-temperature setting region thereof is equivalent to a portion which is not quenched, and a high-temperature setting region thereof is equivalent to a portion which is quenched. When a sheet material is arranged above this low-temperature setting region and the low-temperature setting region is entirely covered (shielded) at the time of infrared heating, there is a tendency that the temperature of the low-temperature setting region decreases than expected or a rising temperature takes a long time. Accordingly, there is a possibility that the high-temperature setting region cannot be fully quenched partially and a slowly changing part unavoidably formed between the high-temperature setting region and the low-temperature setting region may be formed more broadly than expected because the quantity of heat which flows into the low-temperature setting region from the high-temperature setting region becomes excessively large.

Therefore, there is a desire of an infrared heating method of a steel plate, contributing to laborsaving of a forming of the steel plate and simplification of forming apparatus while contributing to exact realization of the demanded temperature distribution.

In a first aspect, there is provided an infrared furnace which can heat a first region and a second region of a work in different temperature regions. The following means are provided:

a member which is positioned between the work and a plurality of infrared lamps apart from the work and the infrared lamps the work, to be arranged above a boundary region between the first and second regions.

In a second aspect, there is provided an infrared heating method for heating a first region and a second region of a work in different temperature regions. The following means are provided:

a member is positioned between the work and a plurality of infrared lamps apart from the work and the infrared lamps, and is arranged above a boundary region between the first and second regions;
an intensity of infrared rays caused to impinge onto the first region is relatively high; and
an intensity of infrared rays irradiating the second region is relatively low.

In a third aspect, there is provided a steel plate, particularly, based on the above second aspect, the following means are provided:

a first region in which rapid-cooling-forming and quenching are carried out after the above heating;
a second region in which cooling-forming is carried out but quenching is not carried out after the above heating; and
a slowly changing part having a width of 20 mm or less, unavoidably formed between the first region and the second region, having an intermediate characteristic of both regions.

Advantageous Effects of the Invention are mentioned below without limitations. The above each aspect contributes to laborsaving of the forming of the steel plate and simplification of forming apparatus while contributing to exact realization of the demanded temperature distribution.

### BRIEF DESCRIPTION OF DRAWINGS

FIG. 1 is a block diagram explaining one example of a basic structure of an infrared furnace according to exemplary embodiments;

FIGS. 2(A) to 2(C) are views illustrating a structure of the infrared furnace according to exemplary embodiment 1 and characteristic distribution of a work heated by this infrared furnace;

FIGS. 3(A) to 3(C) are views illustrating a structure of the infrared furnace according to exemplary embodiment 2 and characteristic distribution of a work heated by this infrared furnace;

FIGS. 4(A) to 4(C) are views illustrating a structure of the infrared furnace according to exemplary embodiment 3 and characteristic distribution of a work heated by this infrared furnace;

FIGS. 5(A) to 5(C) are views illustrating a structure of the infrared furnace according to exemplary embodiment 4 and characteristic distribution of a work heated by this infrared furnace;

FIGS. 6(A) to 6(C) are views illustrating a structure of the infrared furnace according to exemplary embodiment 5 and characteristic distribution of a work heated by this infrared furnace;

FIGS. 7(A) to 7(E) are views illustrating a structure of the infrared furnace according to exemplary embodiment 6 and characteristic distribution of a work heated by this infrared furnace, further a mesh part of a member shielding infrared rays and a modification thereof;

FIGS. 8(A) to 8(C) are views illustrating a structure of the infrared furnace according to exemplary embodiment 7 and characteristic distribution of a work heated by this infrared furnace;

FIG. 9 is a view showing an outline of experiment 1;

FIGS. 10(A) and 10(B) are graphs showing results of experiment 1;

FIG. 11 is a graph showing results of experiment 2; and

FIG. 12 is a graph showing results of experiment 3.

### PREFERRED MODES

Exemplary embodiments of the present invention can produce the following effects. In addition, in the following explanation, it is assumed that the infrared heating of the first region is carried out to a higher temperature than the second region, the first region is quenched by rapid-cooling-forming after infrared heating; on the other hand, the second region is not quenched.

(1) Since a member shields a boundary region between the first region and the second region, a portion, which adjoins the first region, of the second region is excessively irradiated with infrared rays, and it prevents this portion from being heated beyond the preset temperature range of the second region. Simultaneously, a falling in temperature of a portion, which adjoins the second region, of the first region is prevented.

(2) Since the member shields a work partially and minimally, it prevents the temperature of the second region from falling in excess. Accordingly, the temperature gradient near a boundary region becomes small, the quantity of heat per unit time propagating to the second region from the first region decreases, and a slowly changing part unavoidably formed between both regions and having an intermediate characteristic of both regions is formed as small as possible.

(3) Since the member's width can be formed narrowly, a support for the member becomes easy inside the infrared furnace.

(4) Since a temperature distribution having a temperature difference required for partial quenching for the work is formed in a heating step, a special step for giving a temperature difference to the work is not necessary and also a special apparatus for giving a temperature difference to the work is not necessary in a forming step.

(5) In that way, a temperature distribution required for one work is realized exactly, and further a strength distribution required for one work can be realized correctly.

It is preferable that the member is disposed along the boundary region so as to cover at least a part of the above-mentioned boundary region.

The member's width is set as preferably 3 to 60 mm, more preferably 5 to 50 mm, 5 to 30 mm, 5 to 20 mm, 5 to 10 mm.

The infrared furnace is preferably provided with one or some controllers which make(s) an output of one or some infrared lamps among a plurality of infrared lamps located in the first region side of the member higher than an output of one or some infrared lamps among a plurality of infrared lamps located in the second region side of the member,

Basically, an output rate of the infrared lamps by the side of the first region and the infrared lamps by the side of the second region may be set depending on a ratio of the preset temperature of the first region and that of the second region. An output intensity of the infrared lamp is controllable by adjusting the electric energy supplied or amount of the current flowing through the cathode emitting infrared rays.

In addition, in a direction in which the infrared lamps and the work oppose each other, a preferable relationship between a first distance between the member and the infrared lamps and a second distance between the member and the work is preferably in a range of the first distance/the second distance=1/9 to 9/1, and more preferably, 2/8 to 8/2, 3/7 to 7/3, 4/6 to 6/4.

Next, preferable other arrangement embodiments of a plurality of infrared lamps are explained. In the following embodiments, etc., the intensity of the infrared rays which impinges onto the first region of the work or with which the first region is irradiated is higher than the intensity of the infrared rays which impinges onto the second region of the same work or with which the second region is irradiated, depending on the arrangement relation of a plurality of infrared lamps.

Some infrared lamps are arranged relatively densely at the first region side of the member, and one or some infrared lamps is/are arranged relatively sparsely at the second region side of the member.

One or some infrared lamps is/are arranged relatively near the work at the first region side of the member, and one or some infrared lamps is/are arranged relatively far from the work at the second region side of the member,

Although the above-mentioned predetermined heat treatment is typically quenching, it may be other heat treatment(s) as long as it is a heat treatment required for heating the first region and the second region in different temperatures.

The above-mentioned member may be partially permeable of infrared rays. Since this member makes some infrared rays penetrate and the second region is also fully heated, the falling in temperature of the first region by the heat conduction from the first region to the second region is prevented.

The above-mentioned member may be of a mesh-like structure. Since the mesh part of this member makes some infrared rays penetrate and the second region is also fully heated, the falling in temperature of the first region by the heat conduction from the first region to the second region is prevented.

A material of the above-mentioned member for shielding (shading or covering) a part or entire of infrared rays can be selected from ceramics, heat-resistant board, heat-resistant iron sheet, heat-resistant silica, etc.

It is preferable that energy density of the infrared lamp(s) is high and the infrared lamp(s) emits near-infrared rays suitable for heating of the comparatively narrow range field. The preferable range of wavelength is 0.8 to 2 micrometers. In addition, it is also possible to use the comparatively long wavelength of infrared rays, in some cases.

As the infrared lamp(s), while lamps having various shapes can be used, especially among them, it is desirable to use a cheap and long-pipe-type with easy attaching to the infrared furnace. According to the present invention, even if the long-pipe-type is used, a sufficient characteristics change for one part can be formed.

As the work suitable for infrared heating, while various steel plates or sheets, for example, a boron steel plate or sheet, hot-dip galvannealed (GA) steel plate or sheet, and hot-dip galvanized (GI) steel plate or sheet are listed, other metal plates or sheets may be sufficient as long as partial heat treatment is possible.

Preferably, a plurality of infrared lamps are arranged at one surface side of the work, and a reflective surface reflecting infrared rays is arranged at the other surface side of the work. As for the reflective surface, like as a mirrored surface or a glossy surface, it is preferable that the infrared reflectance is high. The reflectance is preferably 60% or more, and more preferably, 70% or more, 80% or more, and 90% or more. The reflective surface can be formed from various metal plating, for example, gold plating, or silver plating, for example.

The other side of the work may be cooled locally by one or some cooling materials (or medium). Accordingly, the characteristic of the work can be changed in spot fashion.

It is preferable that a plurality of infrared lamps are arranged planar or in three dimensions, depending on the profile or desired characteristic distribution of the work.

The preferable steel plate as parts for vehicles comprises the first region in which rapid-cooling-forming and quenching are carried out after infrared heating, the second region in which cooling is carried out simultaneously with the first region but rapid-cooling is not carried out thus quenching is not carried out, and the slowly changing part having narrow width formed unavoidably between the first region and the second region and having an intermediate characteristic of both regions. It is confirmed that the width of the slowly changing part can be 20 mm or less and further 10 mm or less, and it is also possible to be 5 mm or less by optimizing conditions.

In addition, the above-mentioned respective embodiments can be suitably combined, as long as the effect of the present invention is achieved.

Hereinafter, exemplary embodiments of the present invention are explained, with referring to Drawings. In addition, reference signs of Drawings used in following explanation are additions for convenience to elements in Drawings in order to help understanding, without intention for limiting the present invention to the mode(s) as illustrated.

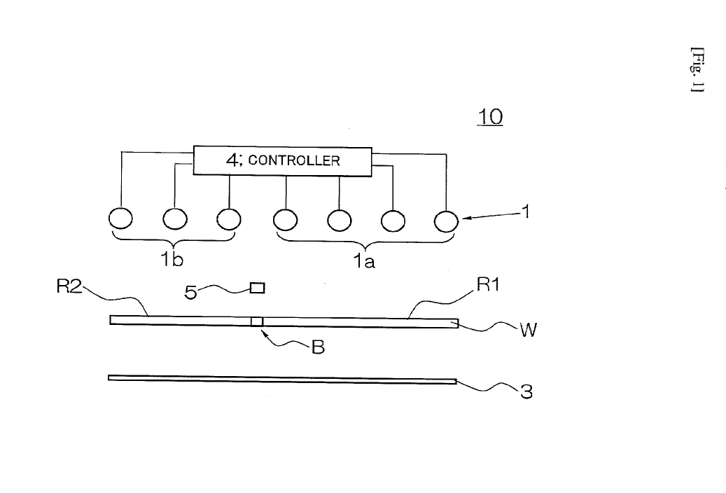

FIG. 1 is a block diagram explaining one example of a basic structure of an infrared furnace 10 according to an exemplary embodiment of the present invention. Referring to FIG. 1, it is required for one work W to form both the first region R1 quenched and formed into high strength by the forming step after infrared heating, and the second region R2 formed into high ductility without being quenched. Therefore, as to the infrared heating by the infrared furnace 10, it is required that the first region R1 is heated to a high temperature range of the austenitizing temperature or more, and the second region R2 is heated to a low temperature range of less than the austenitizing temperature.

The infrared furnace 10 has a plurality of infrared lamps 1 opposing the work W, and a member 5 arranged above a boundary region B between the first region R1 and the second region R2. A plurality of infrared lamps 1 are arranged at one surface side of the work W. A reflective surface 3 reflecting infrared rays emitted from a plurality of infrared lamps 1 is arranged at the other surface side of the work. Alternatively, when a plurality of infrared lamps 1 are arranged below the work, the member 5 is arranged above a boundary region B in an area below the work W, and when the work W is provided in a standing posture and a plurality of infrared lamps 1 are arranged on the side of the work W, the member 5 is arranged above the boundary region B on the lateral side of the work W.

Furthermore, the infrared furnace 10 is provided with a controller 4 performing on-off control and output control of a plurality of infrared lamps 1. For example, among a plurality of infrared lamps 1, the controller 4 can make an output of one or some infrared lamps 1a located in the first region R1 side of the member 5 higher than an output of one or some infrared lamps 1b located in the second region R2 side of the member 5.

In addition, some controllers 4 may be provided one by one relationship with a plurality of infrared lamps 1, and the output intensity of the infrared lamps 1 may be adjusted individually. Moreover, when supporting, the work W by some pins from the bottom, it is preferable that a plurality of infrared lamps 1 are arranged on the upper side as shown in FIG. 1, and when hanging the work W from a top, it is preferable that a plurality of infrared lamps 1 are arranged on the lower side. In various exemplary embodiments mentioned later, one or plurality of controllers 4 is/are suitably used for output adjustment of plural infrared lamps 1.

Here, an effect resulting from installation of the reflective surface 3 is explained, referring to experimental results.

As shown in FIG. 1, the rate of temperature increase of 1.6-mm-thick boron steel plate (work W) was measured, in a case where a plurality of infrared lamps 1 are arranged only in one surface side of the work W and the reflective surface 3 is arranged on the other side of the work W, that is, in the case of single-sided heating, and in a case where a plurality of infrared lamps 1 are arranged on one surface side and the other side of the work W, that is, in the case of both-sides heating. Simultaneously, the temperature difference between the one surface side and the other side of this boron steel plate was measured. In addition, as to both-sides heating, it requires about double electric energy compared with single-sided heating because of requiring double number of infrared lamps 1.

A time to reach 900 degrees Celsius from room temperature was 31.4 seconds for single-sided heating, it was 29.6 seconds for both-sides heating and there was no significant difference in both the rate of temperature increase. Therefore, according to single-sided heating, it is recognized that the short enough time of temperature increase of the steel plate is obtained, attaining energy saving. Moreover, also in the case of single-sided heating, the temperature difference between the one surface side and the other side of the boron steel plate is controlled within 5 degrees Celsius, and this temperature difference is within a satisfactory level on temperature controlling.

### Exemplary Embodiment 1

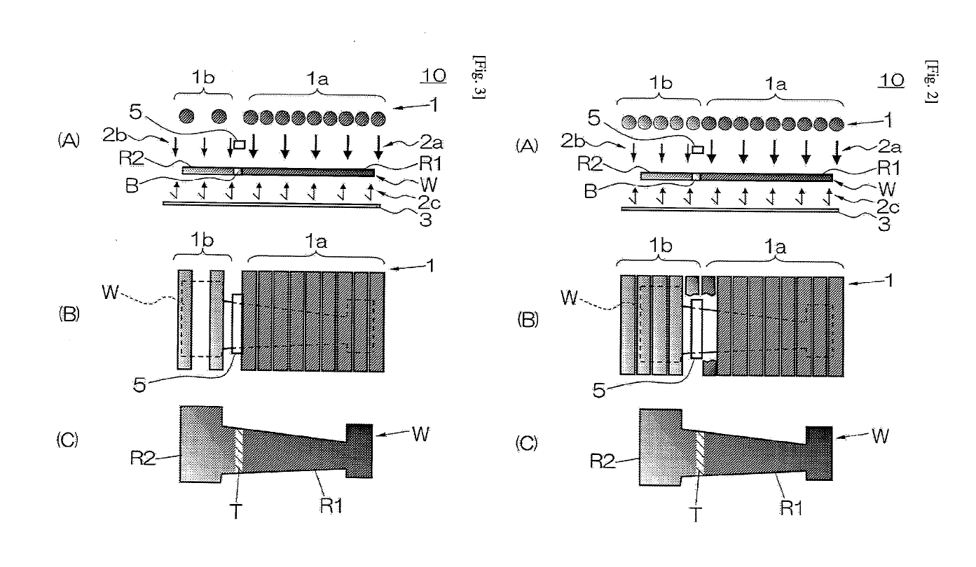

FIG. 2 (A) is a front view schematically illustrating an inner structure of an infrared furnace according to exemplary embodiment 1, FIG. 2 (B) is a top plan view of FIG. 2 (A), and FIG. 2 (C) is a top plan view showing characteristic distribution of a work heated by the infrared furnace of FIG. 2 (A). In addition, in FIG. 2 (B), a part of a plurality of infrared lamps 1 is removed for the sake of the convenience in illustrating a member 5.

Referring to FIG. 2 (A) and FIG. 2 (B), the infrared furnace 10 of exemplary embodiment 1 is provided with a plurality of infrared lamps opposing the one surface of the work W and in which output adjustment is free, a reflective surface 3 opposing the other side of the work W and reflecting infrared rays, and the member 5 arranged above a boundary region B of the work W. The member 5 is extended in the width direction of the work W along the boundary region B so as to shield (cover) the boundary region B.

The infrared heating method of the work W by this infrared furnace 10 is explained. The controller 4 shown in FIG. 1 controls the output of a plurality of infrared lamps 1 as follows. That is, among a plurality of infrared lamps 1, some infrared lamps 1a located (opposing the first region R1) in the first region R1 side of the member 5 emit the infrared light 2a having high intensity, and some infrared lamps 1b located (opposing the second region R2) in the second region R2 side of the member 5 emit the infrared light 2b having low intensity. Therefore, the infrared light 2a having high intensity impinges onto the one surface of the first region R1, the infrared light 2b having low intensity impinges onto the one surface of the second region R2, and simultaneously, the reflective light 2c from the reflective surface 3 impinges onto the other side of the work W.

With such infrared heating, the first region R1 is heated to a high temperature at which quenching is possible, and the second region R2 is heated to a low temperature at which no quenching is performed. The member 5 on the boundary region B prevents a portion which adjoins the first region R1 of the second region R2 from being excessively irradiated with the infrared light 2a having high intensity and being heated exceeding the preset temperature of the second region R2. Simultaneously, the excessive falling of temperature of the portion which adjoins the second region R2 of the first region R1 is prevented. Furthermore, since the member 5 shields the work W at a minimum extent, it prevents the temperature of the second region R2 from excessive falling than the preset. Accordingly, a temperature gradient taken across the boundary region B becomes small, the quantity of heat per unit time propagated to the second region R2 from the first region R1 decreases, and as shown in FIG. 2 (C), the width of the slowly changing part with an intermediate characteristic of both the regions R1 and R2 unavoidably formed between both regions R1 and R2 is formed as small as possible.

Thus, in the infrared furnace 10, since highly precise temperature distribution is given to the work W, a special step for giving a temperature difference to the work W is unnecessary and also a special apparatus for giving a temperature difference to the work W is unnecessary in a forming step at a subsequent process.

### Exemplary Embodiment 2

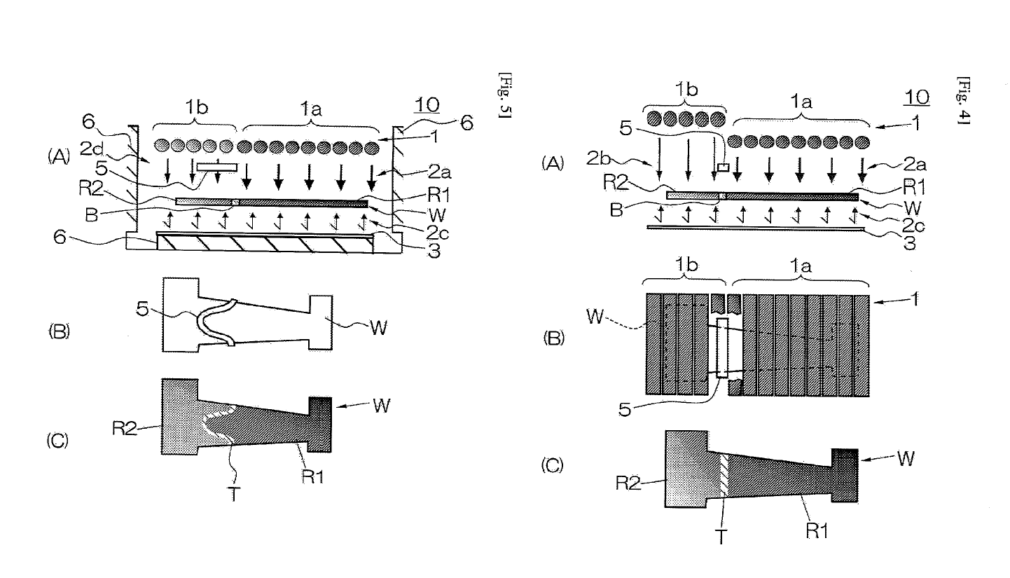

FIG. 3 (A) is a front view schematically illustrating an inner structure of an infrared furnace according to exemplary embodiment 2, FIG. 3 (B) is a top plan view of FIG. 3 (A), and FIG. 3 (C) is a top plan view showing characteristic distribution of a work heated by the infrared furnace of FIG. 3 (A).

Referring to FIG. 3 (A), exemplary embodiment 2 is characterized in that the intensity of infrared rays which impinges onto the one surface of the work W can be variable, depending on the position of the work W, according to the arrangement density of a plurality of infrared lamps 1. In the explanation of the following exemplary embodiment 2, the difference between this exemplary embodiment 2 and the above-mentioned exemplary embodiment 1 is mainly explained, and for common features of both exemplary embodiments, the explanation of exemplary embodiment 1 is suitably referred to.

Referring to FIG. 3 (A) and FIG. 3 (B), in the infrared furnace 10 of exemplary embodiment 2, some infrared lamps 1a are arranged relatively densely at the first region R1 side of the member 5 arranged above the boundary region B of the work W, and one or some infrared lamps 1b are arranged relatively sparsely at the second region R2 side of this member 5. Therefore, even if some infrared lamps 1a and 1b emit infrared rays at similar intensity, the infrared light 2a having high intensity impinges onto the one surface of the first region R1, the infrared light 2b having low intensity impinges onto the one surface of the second region R2, and simultaneously, the reflective light 2c from the reflective surface 3 impinges onto the other side of the work W.

### Exemplary Embodiment 3

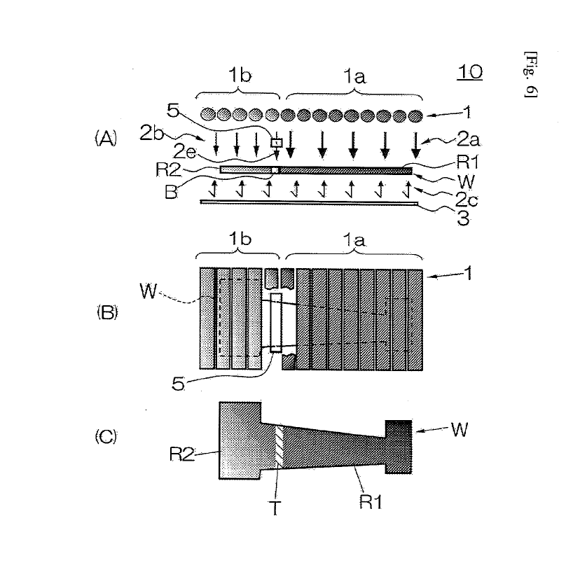

FIG. 4 (A) is a front view schematically illustrating an inner structure of an infrared furnace according to exemplary embodiment 3, FIG. 4 (B) is a top plan view of FIG. 4 (A), and FIG. 4 (C) is a top plan view showing characteristic distribution of the work heated by the infrared furnace of FIG. 4 (A). In addition, in FIG. 4 (B), a part of a plurality of infrared lamps 1 is removed for the sake of the convenience in illustrating the member 5.

Referring to FIG. 4 (A), exemplary embodiment 3 is characterized in that the intensity of infrared rays which impinge onto the one surface of the work W can be variable, depending on the position of the work W, according to the distance between a plurality of infrared lamps 1 and the work W. In the explanation of the following exemplary embodiment 3, the difference between this exemplary embodiment 3 and the above-mentioned exemplary embodiment 1 is mainly explained, and for common features of both exemplary embodiments, the explanation of exemplary embodiment 1 is suitably referred to.

Referring to FIG. 4 (A) and FIG. 4 (B), in the infrared furnace 10 of exemplary embodiment 3, some infrared lamps 1a are arranged relatively near the work W at the first region R1 side of the member 5 arranged above the boundary region B of the work W, and some infrared lamps 1b are arranged relatively far from the work W at the second region R2 side of this member 5. Therefore, even if some infrared lamps 1a and 1b emit infrared rays at similar intensity, the infrared light 2a having high intensity impinges onto the one surface of the first region R1, the infrared light 2b having low intensity impinges onto the one surface of the second region R2, and simultaneously, the reflective light 2c from the reflective surface 3 impinges onto the other side of the work W.

### Exemplary Embodiment 4

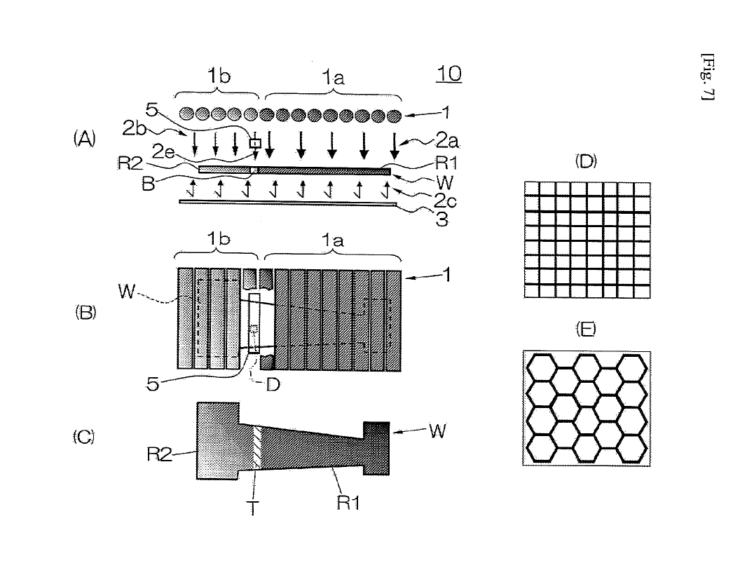

FIG. 5 (A) is a front view schematically illustrating an inner structure of an infrared furnace according to exemplary embodiment 4, FIG. 5 (B) is a top plan view omitting a plurality of infrared lamps of FIG. 5 (A), and FIG. 5 (C) is a top plan view showing characteristic distribution of a work heated by the infrared furnace of FIG. 5 (A).

Referring to FIG. 5 (A), exemplary embodiment 4 is characterized in that one or plural heat storage materials are arranged around the work W. In the explanation of the following exemplary embodiment 4, the difference between this exemplary embodiment 4 and the above-mentioned exemplary embodiment 1 is mainly explained, and for common features of both exemplary embodiments, the explanation of exemplary embodiment 1 is suitably referred to.

Referring to FIG. 5 (A), in the infrared furnace 10 of exemplary embodiment 4, a plurality of infrared lamps 1 are arranged above the work W, and heat storage materials 6 are arranged in the remaining three directions, respectively. The stored heat is radiated from a plurality of heat storage materials, which helps that the second region R2 is heated at a temperature less than the quenching temperature. In addition, the heat storage material 6 is applicable to other exemplary embodiments. A ceramic heat-resistant board etc. can be used as the heat storage material 6.

Moreover, the member 5 arranged above a curved boundary region B of the work W is formed in a shape of a curve according to the profile of the first and second regions R1 and R2. According to the shape of the boundary region B or the member 5, as shown in FIG. 5 (C), the profile of a transition part T is also formed in a shape of a curve. In addition, the member 5 can be circularly formed according to a profile of a circular second region R2, or can be formed in a square shape according to a profile of a squarely second region R2.

### Exemplary Embodiment 5

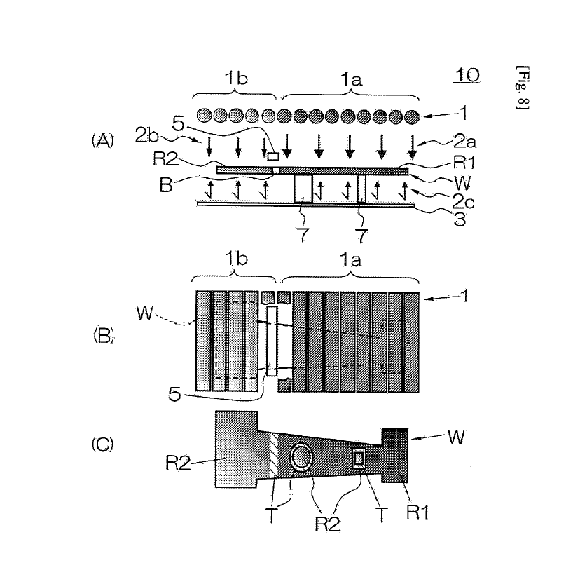

FIG. 6 (A) is a front view schematically illustrating an inner structure of an infrared furnace according to exemplary embodiment 5, FIG. 6 (B) is a top plan view of FIG. 6 (A), and FIG. 6 (C) is a top plan view showing characteristic distribution of a work heated by the infrared furnace of FIG. 6 (A). In addition, in FIG. 6 (B), a part of a plurality of infrared lamps 1 is removed for the sake of the convenience illustrating the member 5.

Referring to FIG. 6 (A), exemplary embodiment 5 is characterized in that an infrared-part-transparency plate is used as a member 5. In the explanation of the following exemplary embodiment 5, the difference between this exemplary embodiment 5 and the above-mentioned exemplary embodiment 1 is mainly explained, and for common features of both exemplary embodiments, the explanation of exemplary embodiment 1 is suitably referred to.

Referring to FIG. 6 (A) and FIG. 6 (B), in the infrared furnace 10 of exemplary embodiment 5, the infrared transmitting member 5 arranged above the curved boundary region B of the work W makes a part of infrared light 2a and 2b emitted from some infrared lamps 1a and 1b penetrate. Especially, the transmitted light 2e that penetrated the member 5 contributes to the prevention of falling in temperature of the second region R2. In addition, a cloudy silica glass and translucent ceramics having desired transmittance can be used as the infrared transmitting member 5.

### Exemplary Embodiment 6

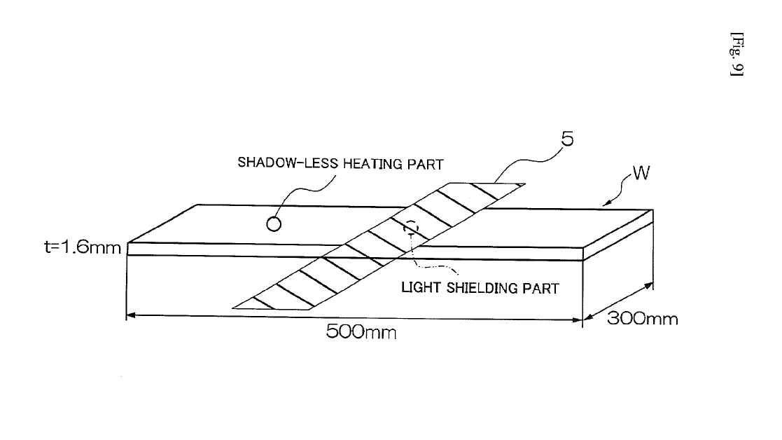

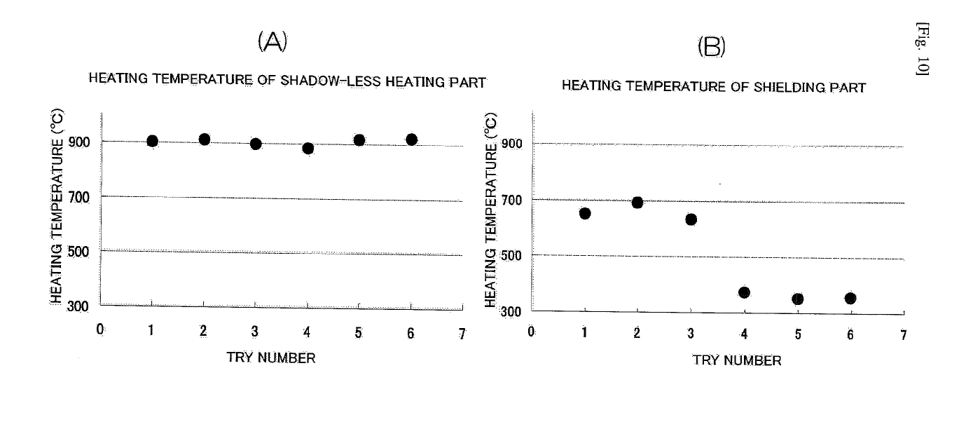

FIG. 7 (A) is a front view schematically illustrating an inner structure of an infrared furnace according to exemplary embodiment 6, FIG. 7 (B) is a top plan view of FIG. 7 (A), and FIG. 7 (C) is a top plan view showing characteristic distribution of the work heated by the infrared furnace of FIG. 7 (A), FIG. 7 (D) is an element on larger scale of the member shown in FIG. 7 (B), and FIG. 7 (E) is a view showing a variation of the part shown in FIG. 7 (D).

Referring to FIG. 7 (B), exemplary embodiment 6 is characterized in that a mesh-like plate is used as a member 5. In the explanation of the following exemplary embodiment 6, the difference between exemplary embodiment 6 and the above-mentioned exemplary embodiment 5 is mainly explained, and for common features of both exemplary embodiments, the explanation of exemplary embodiment 5 is suitably referred to.

Referring to FIG. 7 (A) and FIG. 7 (B), in the infrared furnace 10 of exemplary embodiment 6, since the member 5 has the mesh-like shape, the member 5 makes a part of infrared light 2a and 2b emitted from some infrared lamps 1a and 1b penetrate. Especially, the transmitted light 2e that penetrated the member 5 contributes to the prevention of falling in temperature of the second region R2. In addition, ceramics having a mesh or net structure or porous ceramics may be used as the member 5.

Referring to FIG. 7 (D), the mesh can be formed in a shape of grid, and referring to FIG. 7 (E), the mesh may be formed in a shape of a honeycomb or in a shape of a hexagon to increase the strength.

### Exemplary Embodiment 7

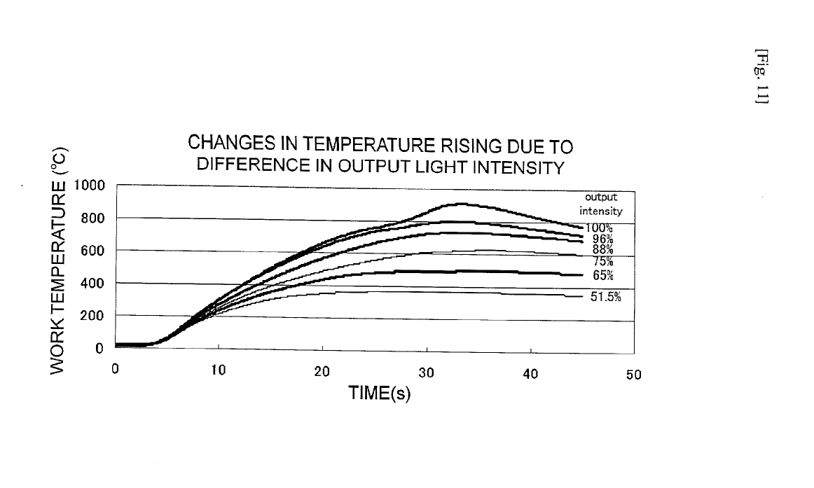

FIG. 8 (A) is a front view schematically illustrating an inner structure of the infrared furnace according to exemplary embodiment 7, FIG. 8 (B) is a top plan view of FIG. 8 (A), and FIG. 8 (C) is a top plan view showing characteristic distribution of the work heated by the infrared furnace of FIG. 8 (A).

Referring to FIG. 8 (A), the infrared furnace 10 of exemplary embodiment 7 is provided with cooling materials (or medium) 7, 7 cooling locally other side of the work W. Referring to FIG. 8 (B) and FIG. 8 (C), in addition to the left end part of the work W opposing some infrared lamps 1b having a low output, portions contacted with cooling materials 7 and 7 respectively also serve as the second regions R2 and R2 by infrared heating, the circumference of these second regions R2 and R2 also serves as the slowly changing part T, and the remainder serves as the first region R1.

In addition, as the cooling material 7, using a temperature absorption member, such as a metal member enclosing ceramics and sodium, it can be contacted on the other side of the work W. Such a temperature absorption member may be used as a pin supporting the work W. Moreover, as the cooling material 7, water and air may be made to blow off from a nozzle arranged on the other side of the work W, and these may be used together with an above-mentioned metal member.

In addition, a number of exemplary embodiments explained above can be used together (or combined) as long as there are no directions.

### Experiment 1

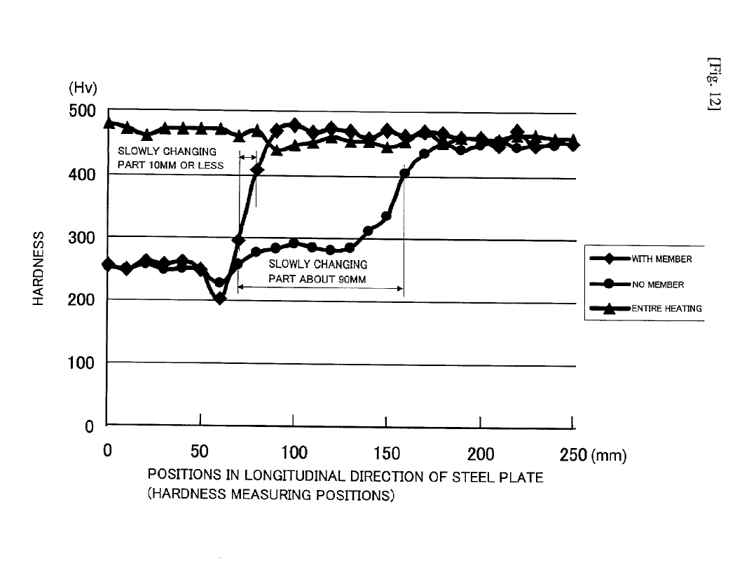

Next, a desirable width of the member 5 as shown in FIG. 2 (A) is examined based on results of experiment 1. FIG. 9 is a view showing an outline of experiment 1, and FIGS. 10 (A) and (B) show graphs showing results of experiment 1. The boron steel plate (500 mm in length, 300 mm in width, and 1.6 mm in thickness) was used as a test work. The test work was subjected to infrared heating with the infrared furnace 10 as shown in FIG. 1. However, the output of a plurality of infrared lamps was made the same, and the infrared heating was carried out for about 40 seconds with covering a part of test work by members shown in the following table, respectively. And in the test work, temperatures of the “shadow-less-heating part” which is not covered with the member and the “shielding part” covered with the member were measured, respectively. “Shadow-less-heating part” is equivalent to the first region R1 shown in FIG. 2 (C), and a “shielding part” is equivalent to the slowly changing part T shown in FIG. 2 (C).

| | | Infrared shield or |
|---|---|---|
| Member No. | Member | penetration |
| 1 | PHI 30 Cylindrical pipe | Shielded |
| 2 | PHI 60 Translucent ceramics | Partial penetration |
| 3 | 20 mm width Shielding bar | Shielded |
| 4 | 100 mm width Shielding bar | Shielded |
| 5 | 100 × 100 Steel plate | Shielded |
| 6 | 100 × 100 Translucent ceramics | Partial penetration |

Referring to FIG. 10 (A), the temperature of “the shadow-less-heating part” was at an almost fixed temperature (900 degrees Celsius) irrespective of the member used for shielding etc. Referring to FIG. 10 (B), on the other hand, the temperature of the “shielding part” fell greatly when the member (No. 4 to 6) having 100 mm width was used and it was maintained at around 700 degrees Celsius when the member (No. 1 to 3) having the width below 60-mm was used.

Heating “a shadow-less-heating part” to a temperature of Ac-3 point or more, and securing the quenching ability in a subsequent forming step and from a view point of preventing the springback after the forming step, the temperature of the “shielding part” is preferably at a neighborhood of Ac-1 point or less; that is, it is preferable around 700 degrees Celsius.

As mentioned above, in order to provide a sufficient infrared shielding effect, the width of the member is preferably 5 to 50 mm, still more preferably 10 to 40 mm in the case where the member is infrared-shielding, and the width of the member is preferably 10 to 70 mm, still more preferably 20 to 70 mm in the case where the member is partially permeable of infrared rays.

### Experiment 2

Here, an example of an output adjusting method for an infrared lamp(s) according to the regional preset temperature (for example, about 400 to 900 degrees Celsius) is explained based on an experimental result. As a work to be subjected to infrared heating, a boron steel plate having 1.6 mm in thickness, 100 mm in length and 80 mm width was used, a thermo couple was attached at the center thereof, the intensity of infrared rays outputted from a plurality of infrared lamps was changed between about 50 and 100%, infrared heating was performed respectively, and the temperature change of a boron steel plate was measured, respectively.

FIG. 11 is a graph showing a result of experiment 2, showing differences in the heating temperature of the steel plate according to differences in infrared output intensity against the steel plate. Referring to FIG. 11, it is recognized that the temperature of the steel plate can be set up freely by output adjustment of infrared lamps, and further the temperature of some predetermined regions of the steel plate can be set up freely by partial output adjustment of a plurality of infrared lamps.

### Experiment 3

Next, in the infrared furnace 10 as shown in FIG. 2 (A), an infrared heating examination was performed for a boron steel plate having 250 mm in length. In detail, the intensity of the infrared rays impinging onto a range of 50 to 250 mm (a region to make into the first region R1) along the longitudinal direction (horizontal direction in FIG. 2(A)) of the boron steel plate was set as high, depending on the desired temperature difference, more than the intensity of the infrared rays similarly impinging onto a range of 0 to 50 mm (a region to make into the second region R2). As the member 5 arranged above the boundary region B, a 20-mm-wide shielding bar was used, and this shielding bar's width direction center line was located on a 50 mm position of the boron steel plate. Vickers hardness distribution (Hv) of the longitudinal direction of the boron steel plate was measured after finishing the infrared heating (refer to the plot “with member” in FIG. 12).

Moreover, as for comparison, except not using the above-mentioned shielding bar, the heating test was performed under the same conditions as the above (refer to the plot of “no member” in FIG. 12), and except not using the above-mentioned shielding bar and also not performing the infrared partial intensity adjustment, the heating test was performed under the same conditions as the above (refer to the plot of “entire heating” in FIG. 12), and Vickers hardness distribution (Hv) was measured, similar to the above, respectively.

Results of the above experiment 3 are shown in FIG. 12. Referring to Vickers hardness distribution of FIG. 12, in the case of the entire heating, naturally, the hardness distribution of the longitudinal direction of the boron steel plate was constant. In the case where the infrared partial input intensity adjustment was performed but the narrow width shielding by the shielding bar was not performed, the hardness was changed gently in a range between 70 to 160 mm of the boron steel plate, and the width of the slowly changing part T became as large as about 90 mm. On the other hand, in the case where, in addition to infrared partial input intensity adjustment, the narrow width shielding by the shielding bar was performed, the hardness was changed sharply in a range between 70 to 80 mm of the boron steel plate, and the width of the slowly changing part T became very narrow at 10 mm or less.

As mentioned above, although exemplary embodiments, etc. of the present invention were explained, the present invention is not limited to the above-mentioned exemplary embodiments, etc., and the further modification, substitution or adjustment can be added, within a scope not deviating from the fundamental technical idea of the present invention.

The entire disclosures of the above Patent Literatures are incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### INDUSTRIAL APPLICABILITY

The present invention is used suitably for heat treatment or heat forming of automobile parts, for example, various pillars and side members or component parts for a door such as an impact bar.

### REFERENCE SIGNS LIST

1 A plurality of infrared lamps
1a One or some infrared lamps opposing the first region
1b One or some infrared lamps opposing the second region
2a Infrared ray emitted from infrared lamps opposing the first region, Infrared ray having high intensity
2b Infrared ray emitted from infrared lamps opposing the second region, Infrared ray having low intensity
2c Reflected light
2e Transmitted light
3 Reflective surface
4 Controller
5 Member shielding or partially transmitting the infrared ray
6 Heat storage material
7 Cooling material (or medium)
10 Infrared furnace, Infrared heating apparatus
W Work
R1 First region, High strength part, High hardness part
R2 Second region, Low strength part, Low hardness part
B Boundary region
T Slowly changing part, Transition part
10 Infrared furnace

1.-12. (canceled)

13. An infrared furnace which can heat a first region and a second region of a work in different temperature regions, comprising:
a plurality of infrared lamps opposing said work,
a member which is positioned between said work and said plurality of infrared lamps apart from the work and the infrared lamps, and is arranged above a boundary region between the first and second regions.

14. The infrared furnace defined in claim 13, wherein said member is disposed along said boundary region so as to cover at least a part of the boundary region.

15. The infrared furnace defined in claim 13, wherein said infrared furnace is provided with at least one controller which makes an output of one or some infrared lamps among said plurality of infrared lamps located in the first region side of the member higher than an output of one or some infrared lamps among said plurality of infrared lamps located in the second region side of the member.

16. The infrared furnace defined in claim 13, wherein some of said infrared lamps are arranged relatively densely at the first region side of the member, and one or some of said infrared lamps is/are arranged relatively sparsely at the second region side of the member.

17. The infrared furnace defined in claim 13, wherein one or some of said infrared lamps is/are arranged relatively near said work at a position(s) of the first region side of said member, and one or some of said infrared lamps is/are arranged relatively far from said work at a position(s) of the second region side of said member.

18. The infrared furnace defined in claim 13, wherein said plurality of infrared lamps are arranged at one surface side of said work, and
a reflective surface reflecting infrared rays is arranged at the other surface side of said work.

19. The infrared furnace defined in claim 13, wherein heat storage material(s) is/are arranged around said work.

20. The infrared furnace defined in claim 13, wherein said member has partial permeability of infrared rays.

21. The infrared furnace defined in claim 13, wherein said member is of a mesh-like form.

22. The infrared furnace defined in claim 13, wherein said infrared furnace is provided with a cooling material(s) cooling locally the other side of said work.

23. An infrared heating method heating a first region and a second region of a work in different temperature regions, comprising:
positioning a member between said work and a plurality of infrared lamps apart from the work and the infrared lamps, wherein the member is arranged above a boundary region between the first and second regions,
causing the infrared rays to impinge onto the first region at a relatively high intensity, and
causing the infrared rays to impinge onto the second region at a relatively low intensity.

24. A steel plate heated by the infrared heating method defined in claim 23, comprising:
a first region in which rapid-cooling-forming and quenching are carried out after said heating,
a second region in which quenching is not carried out, and
a slowly changing part which is unavoidably formed between the first region and the second region, said slowly changing part having an intermediate characteristic of both regions;
wherein said slowly changing part has a width of 20 mm or less, and said steel plate is provided with different strength regions.
